(19) United States
(12) Patent Application Publication
(10) Pub. No.: US 2006/0247950 A1
(43) Pub. Date: Nov. 2, 2006

(54) System of health-care information management

(76) Inventors: Anuthep Benja-Athon, New York, NY (US); Theda Benja-Athon, Port Washington, NY (US)

Correspondence Address: ANUTHEP BENJA-ATHON, 210 E 36TH ST., NEW YORK, NY, 10016, US

(21) Appl. No.: 11/431,046

(22) Filed: May 10, 2006

Related U.S. Application Data
(63) Continuation-in-part of application No. 11/114,763, filed on Apr. 27, 2005.

(51) Int. Cl. G06Q 10/00; H04M 11/00; G10L 15/26

(52) U.S. Cl. 705/2; 704/235; 379/93.15

(57) ABSTRACT

A system of management of digital data comprising health, health-care and health-care related information on patients and physicians generate and view by patients and physicians wherein data are managed by computer programs in computers and servers to effect generations and expansions of data by physicians and patients.

This application is a continuation-in-part of Ser. No. 11/114,763 entitled A System of Influencing Health-Care Utilizations filed Apr. 27, 2005 which are pending.

### FIELD OF INVENTION

Health-care information generations and expansions by patients and physicians.

### BACKGROUND OF THE INVENTION

Earlier patent applications providing the best health-care system were filed by both patent applicants. Further to same, this patent application serves to enhance the achievements of said pending patent application Ser. No. 11/114,763 to achieve the goals and objectives stated in said pending application.

The consequences of the present invention are the tremendous saving of billions of dollars each year and improvement of standard of living and quality of life for billions of people including hundreds of millions of patients and physicians. Furthermore, millions of lives in U.S.A. and the world can be saved by the present invention.

### SUMMARY OF THE INVENTION

A system of management of data comprising first digital data on health, health-care and health-care related information repeatedly generated by millions of patients using Web pages comprising forms or templates and second digital data on health, health-care and health-care related information on patients derived from digital audio data repeatedly generated by tens of thousands physicians in their own settings, premises or offices, wherein said digital audio data are converted into second digital data. Said data are managed by computer programs and database management systems and means for managing data to organize and characterize said data and to input and store said data in and output said data from databases wherein said data are viewable on display screens of computers and other electronic devices and manipulated including additions and modifications by said physicians and patients to effect generations and expansions of said data and databases by physicians and patients.

### DESCRIPTION OF PREFERRED EMBODIMENTS

The present invention is a method of managing data and a system of data management of data comprising digital data on health, health-care and health-care related information on patients and physicians. Said data are generated by patients and physicians. Said data comprises first digital data comprising health, health-care and health-care related information on patients generated by said patients and second digital data on health, health-care and health-care related information derived from digital audio data comprising health, health-care and health-care related information on patients generated by physicians using voice recorder means for recording said audio data.

The process of generating first digital data by patients comprises a process of presenting Web pages comprising forms or templates viewable on and useable on a display screen. Any patient can fill in the information on his/her data or information health, health-care and health-care related information in said forms or templates according to the instructions on said forms or templates. Said process of filling forms or templates with said data or information can be repeatedly and perpetually done by a patient to achieve the goals and objectives of the present invention. Thus, milllions or billions of patients in their settings and premises will perform said role using said forms or templates yielding millions or billions of Web pages of viewable data by said patients and their physicians. Technologies infra and their derivatives and the like support said process of generating first digital data and also the processes of processing, tagging, categorizing, characterizing and organizing said data, and inputting said data into and outputting or retrieving said data from databases to achieve the goals and objectives of the present invention.

Said process of generating second digital text data comprising health, health-care and health-care related information on patients by physicians in their settings, premises and offices comprises a process of using digital voice recorder means for recording and/or transmitting audio data (DVRs) and/or mobile or cellular phone means for recording and/or transmitting audio data by tens of thousands of physicians who dictate their voice or speech comprising information comprising health, health-care and health-care related information on patients into said DVRs or said other mobile means. Today, the more popular DVRs are those made by Sony and Olympus. The DVRs are portable and powered by disposable and/or rechargeable batteries like other said mobile means. The Sony and Olympus formats of the digital audio files are in .msv and .dss formats, respectively, are repeatedly and perpetually created by said physicians who will be taught the speech recognition grammar specification based on the Medical Speech Grammars^{SM} based on the work in earlier patent filings of this applicant and his other co-applicant.

Said audio data in said formats (or .wav format and other formats) and the like are transmitted by or from said DVRs or devices via cable and/or wireless means for transmitting data to computers and/or servers in a network or networks of computers and servers. In said computers and/or servers said digital audio data in whatever said .msv and .dss formats can be converted into .wav format using software means for converting said formats into .wav format. Said audio data are then converted into second digital text data.

In said computers and/or servers, the process of converting digital audio data into said second digital text data is achieved by using speech-to-text technologies such as, but not limited, speech-to-text means for converting speech or voice to text or .wav-to-text means for converting speech to text are used. Such technologies include, but not limited to, software such as Dragon Naturally Speaking Server Edition (Nuance Communication), Microsoft speech recognition technology infra (Microsoft, Inc.), Philips speech recognition technology (Philips) and any computer software adaptable to convert voice or speech data to text data

Moreover, said speech recognition technology is also provided by Microsoft technologies such as, but not limited to, computer programs, speech recognition and Web development technologies and Net such as, but not limited to, ASP.NET, Visual Studio.NET, Visual Studio.Net 2003 Speech Tools, Speech Application Software Development Kit, Speech Server 2004 R2, Speech Application Programming Interface (SAPI), Speech Application Language Tags (SALT) and ECMAScript and JavaScript and the like and their derivatives and related.

Said data are markup using Markup Languages infra, stored in databases, inputted into and outputted from databases by system means for managing databases, wherein said data are viewable on display screen means for displaying data by physicians and patients by means for displaying data on said display screen means to effect generations and expansions of said data by physicians and patients. The technologies infra, their derivatives and the like support the present invention.

Said process of managing data comprises a process of using Markup Languages on said first and second data such as, but not limited to, eXtensible Markup Language (XML) and Hypertext Markup Language (HTML) and their derivatives and the like. Said languages organize said data by creating tag means for constructing a specific document structure. Said process of managing data is further supported by technologies described herein to achieve the goals and objectives of the present invention.

Said process of managing said data further comprising a process of using computer programming languages are used such as, but not limited to, scripting programming languages such as, but not limited to, general-purpose dynamic languages such as, but not limited to, PHP or Hypertext Preprocessor.

Furthermore, said process of managing said data comprises a process of using computer languages such as Structured Query Languages (SQL) for creating, modifying, retrieving and manipulating data from relational database management systems (RDBMS) and object-relational database management systems (ODBMS). SQL such as, but not limited to, MySQL, Oracle, IBM DB2, Microsoft SQL Server, Transact-SQL, Sybase SQL Server, PostgreSQL, Firebird and SQLite and their derivatives and related are used.

Said processes of managing data comprising said first and second digital data repeatedly and perpetually retrievable, viewable, usable and expandable by additions, modifications and/or comments by said physicians and patients using computers and other electronic devices (multimodal such as, but not limited to, mobile-based devices such as mobile or cellular phones) are supported by technologies supra, their derivatives and the like to achieve the goals and objectives of the present invention.

Although the preferred embodiments have been described, it will be appreciated by those skilled in the art and technologies that variations, additions and adaptations to the present invention can be made including the uses and applications of technologies neither described nor identified herein without departing from the spirit of the invention and the scope of the claims.

1. A method of generating and expanding data comprising health, health-care and health-care related information on or relating to patients and physicians by physicians and patients viewable on display screen means for displaying data by physicians and patients comprising first digital data on health, health-care and health-care related information generated by patients and second digital data on health and health-care related information on patients derived from the conversions of audio data generated by physicians using voice recorder means for recording said audio data, wherein said audio data are transmitted by means for transmitting said audio data via cable or wireless means for transmitting said audio data to computers and/or servers in a network or networks of computers and servers wherein said audio data are converted into said second digital data, wherein said data are markup, inputted into and retrieved from databases to produce said data comprising said first and second data displayable on computer screens by a process of displaying said data on display screen means for displaying data viewable by physicians and patients to effect said generations and expansions of said data by said physicians and patients comprises:
a process of generating first digital data by patients;
a process of generating audio data by physicians;
a process of transmitting audio data via cable means for transmitting data;
a process of transmitting audio data via wireless means for transmitting data;
a process of converting audio data into said second digital data; and
a process of managing data.

2. The method according to claim 1 wherein said process of managing data comprises a process of using Markup Languages on said data.

3. The process of using Markup Languages according to claim 2 includes a process of using the eXtensible Markup Language also known as XML on said data.

4. The process of using Markup Languages according to claim 2 includes a process of using the Hypertext Markup Language also known as HTML on said data.

5. The method according to claim 1 wherein said process of managing data comprises a process of using tag means for organizing digital data.

6. The method according to claim 1 wherein said process of managing data comprises a process of using tag means for labeling digital data

7. The method according to claim 1 wherein said process of managing data comprises a process of using tag means for categorizing digital data

8. The method according to claim 1 wherein said process of managing data comprises a process of using tag means for organizing digital data

9. The method according to claim 1 wherein said process of managing data comprises a process of storing data into databases by system means for storing databases.

10. The method according to claim 1 wherein said process of managing data comprises a process of organizing data in databases by system means for organizing databases.

11. The method according to claim 1 wherein said process of managing data comprises a process of inputting data into databases by system means for managing databases.

12. The method according to claim 1 wherein said process of managing data comprises a process of retrieving data from databases by system means for managing databases.

13. The method according to claim 1 wherein said process of managing data comprises a process for displaying data comprising said first and second data from databases on displaying screen means for displaying data.

14. A method of managing data comprising health, health-care and health-care related information on or relating to patients and physicians in computers and servers of a network or networks of computers and servers comprising inputting digital data into databases in database system means for managing data and outputting digital data from databases viewable on display screen means for displaying said data by physicians and patients, wherein digital data comprising first digital data generated by patients and second digital data converted from digital audio data comprising health, health-care and health-care related information on patients generated by physicians using voice recorder means for recording audio data wherein audio data are transmitted by means for transmitting audio data to said computers or servers wherein data are markup and processed, wherein said data are transmitted via cable or wireless means for transmitting data to and from computer means for managing, storing and displaying said data for producing outcomes displayable on display screen means for displaying data by a process of displaying said data viewable by physicians and patients to effect generations and expansions of said data by physicians and patients comprises:
a process of generating first digital data by patients;
a process of generating audio data by physicians;
a process of transmitting audio data via cable means for transmitting data;
a process of transmitting audio data via wireless means for transmitting data;
a process of converting audio data into said second digital data; and
a process of managing data.

15. A system of data management of data comprising first digital data on health, health-care and health-care related information generated by patients and second digital data on health, health-care and health-care related information derived from digital audio data comprising health, health-care and health-care related information on patients generated by physicians using voice recorder means for recording audio data and transmitted by or from means for transmitting audio data via wireless or cable means for transmitting data to computers and/or servers in a network or networks of computers and servers wherein audio data are converted into said second digital data, wherein said data are markup, stored in databases and inputted into and outputted from databases by system means for managing databases, wherein said data are viewable on display screen means for displaying data by physicians and patients by means for displaying data on said display screen means to effect generations and expansions of said data by physicians and patients comprises:
a process of generating first digital data by patients;
a process of generating audio data by physicians;
a process of transmitting audio data via cable means for transmitting data;
a process of transmitting audio data via wireless means for transmitting data;
a process of converting audio data into said second digital data; and
a process of managing data.

16. The system of data management of data according to claim 15 wherein said process of managing data comprises a process of using Markup Languages on said data.

17. The system of data management of data according to claim 15 includes a process of using the eXtensible Markup Language also known as XML on said data.

18. The process of using Markup Languages according to claim 15 includes a process of using the Hypertext Markup Language also known as HTML on said data.

19. The system of data management of data according to claim 15 comprises a process of using tag means for organizing digital data.

20. The system of data management of data according to claim 15 comprises a process of using tag means for categorizing digital data.
